(19) United States
(12) Patent Application Publication
(10) Pub. No.: US 2020/0337288 A1
(43) Pub. Date: Oct. 29, 2020

(54) FISHING FLOAT SYSTEMS AND METHODS OF USING THE SAME

(71) Applicant: David Ray Disney, Ridgway, IL (US)

(72) Inventor: David Ray Disney, Ridgway, IL (US)

(21) Appl. No.: 16/801,532

(22) Filed: Feb. 26, 2020

Related U.S. Application Data
(60) Provisional application No. 62/840,121, filed on Apr. 29, 2019.

(51) Int. Cl. A01K 93/00

(52) U.S. Cl. CPC A01K 93/00

(57) ABSTRACT

Exemplary embodiments are disclosed of fishing float systems and methods of using the same. In exemplary embodiments, a fishing float system generally includes at least one insert configured to be slidably and engagingly received within an open end portion of a tube having a hollow interior. The engagement of the at least one insert within the open end portion of the tube may create a substantially water tight seal between the at least one insert and the tube that may substantially prevent or inhibit the ingress of water into the hollow interior of the tube, thereby allowing the tube to be usable as a fishing bobber or float.

### CROSS-REFERENCE TO RELATED APPLICATION

This application claims priority to and the benefit of U.S. Provisional Patent Application No. 62/840,121 filed Apr. 29, 2019, which is incorporated herein by reference in its entirety.

### FIELD

The present disclosure generally relates to fishing float systems and methods of using the same.

### BACKGROUND

This section provides background information related to the present disclosure which is not necessarily prior art.

A fishing float or bobber is a commonly used item of angling equipment that is attached to a fishing line. A fishing float or bobber may have several purposes including suspending a baited hook or lure at a predetermined depth in the water and/or providing a visual strike or bite indicator. A fishing float or bobber may also be used for carrying a baited hook or lure to an inaccessible area, such as by allowing the fishing float or bobber to drift along with a current to the inaccessible area (e.g., underneath a tree branch, dock, other structure, etc.).

### DRAWINGS

The drawings described herein are for illustrative purposes only of selected embodiments and not all possible implementations, and are not intended to limit the scope of the present disclosure.

FIG. 1 shows an exemplary embodiment of a fishing float system attached to a fishing line above a fishing lure. FIG. 1 also shows illustrates a knot attached to the fishing line such that the fishing float system is configured in a slip mode of operation according to exemplary embodiments.

FIG. 2 shows the fishing float system in FIG. 1 with the first or upper boss (broadly, an insert, retainer, or component) slidably removed from the open end portion of the straw (broadly, tube or tubular member). The hollow interior of the straw is thus accessible through the open end portion of the straw from which the first boss was slidably removed. FIG. 2 also shows items or objects (e.g., BBs, a glow stick, etc.) that may added into the hollow interior of the straw to thereby adjust the fishing float system.

FIGS. 3 and 4 are perspective views of an exemplary boss (broadly, an insert, retainer, or component) shown in FIGS. 1 and 2. The boss is configured to be slidably and engagingly received within the open end portion of a straw (broadly, a tube or tubular member) of a fishing float system according to exemplary embodiments.

FIGS. 5 and 6 are top and side views illustrating an exemplary spring configuration that may be used as a fishing line keeper with the boss shown in FIGS. 3 and 4 and the fishing float system shown in FIGS. 1 and 2 according to exemplary embodiments.

FIGS. 7 and 8 are perspective views of an exemplary boss (broadly, an insert, retainer, or component) according to another exemplary embodiment in which the boss is configured to be slidably and engagingly received within the open end portion of a straw (broadly, a tube or tubular member) of a fishing float system according to exemplary embodiments.

FIGS. 9 and 10 are top and side views illustrating an exemplary spring configuration that may be used as a fishing line keeper with the boss shown in FIGS. 7 and 8 according to exemplary embodiments.

Corresponding reference numerals may indicate corresponding (although not necessarily identical) parts throughout the several views of the drawings.

### DETAILED DESCRIPTION

Example embodiments will now be described more fully with reference to the accompanying drawings.

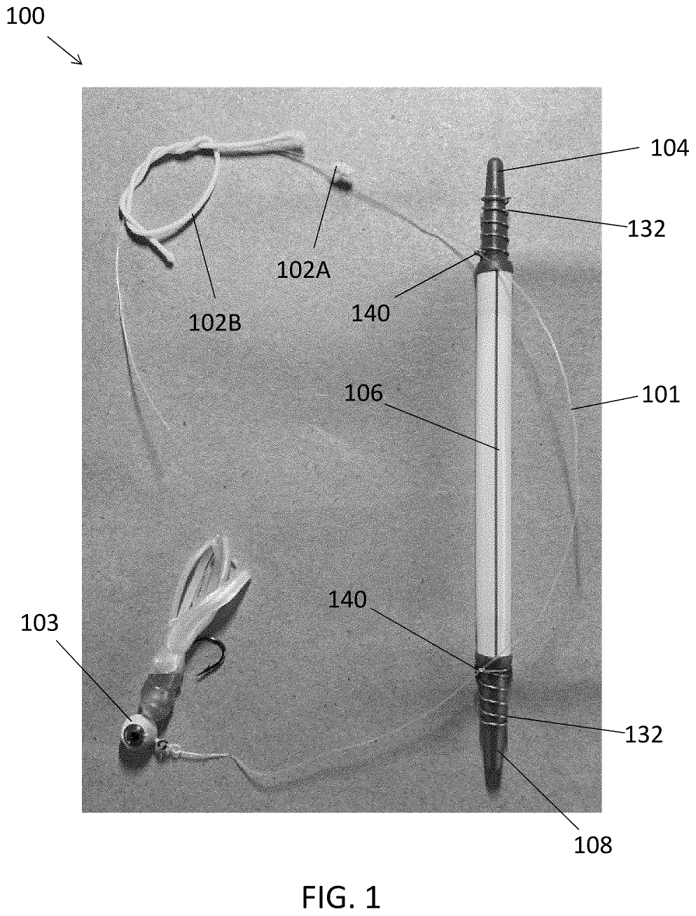

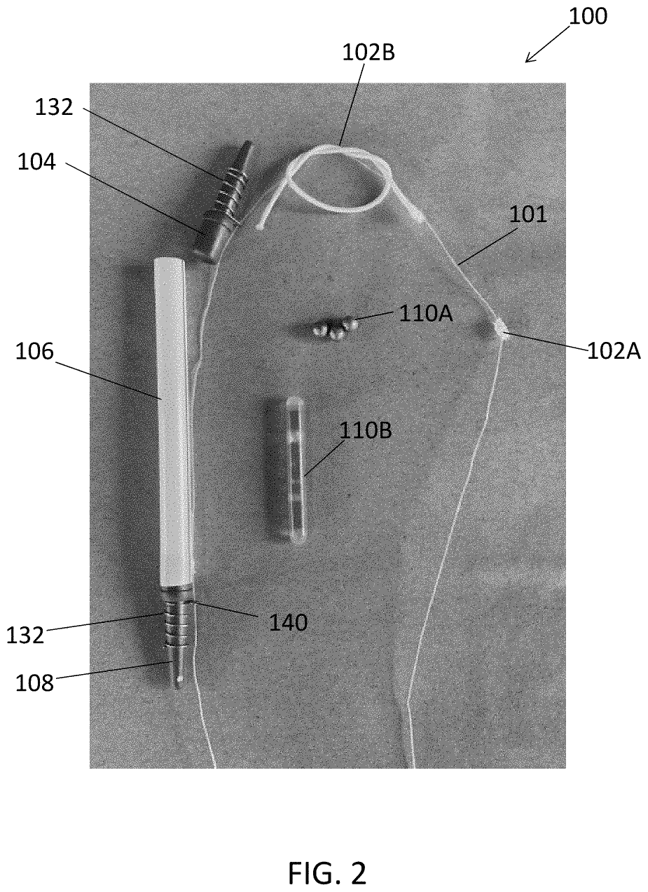

Disclosed herein are exemplary embodiments of fishing float systems and methods of using the same. For example, FIGS. 1 and 2 illustrate a fishing float system 100 according to an exemplary embodiment embodying one or more aspects of the present disclosure. As shown in FIGS. 1 and 2, the fishing float system 100 includes first and second (or upper and lower) bosses 104, 108 (broadly, inserts, retainers, or components) configured to be slidably and engagingly received within the opposite open end portions of a tube or tubular member 106 (e.g., straw, rubber tube, plastic tube, tubular member having a round, circular, or non-circular cross section, etc.). The engagement of the bosses 104, 108 within the open end portions of the tube 106 preferably creates a substantially water tight seal between each boss 104, 108 and the tube 106 that substantially prevents or inhibits the ingress of water into the hollow interior of the tube 106.

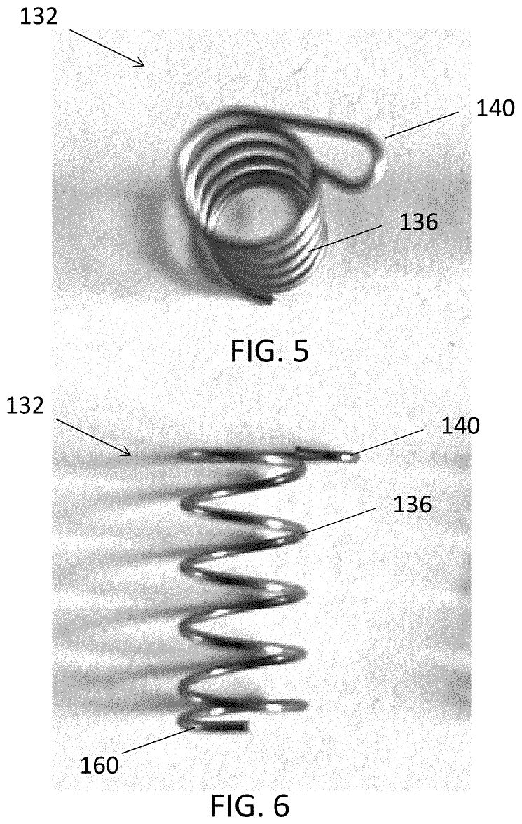

As shown in FIG. 1, the fishing float system 100 is attached to a fishing line 101 above a fishing lure 103. A knot 102A is also attached to the fishing line 101 to thereby adjust, convert, or configure the fishing float system 100 for a slip mode of operation. As shown in FIG. 1, the fishing line 101 has been slidably thread or positioned through the eyelets 140 of the fishing line keepers 132 (FIGS. 5 and 6) disposed along the upper and lower bosses 104, 108. In this example, the tube 106 and upper boss 104 are slidable upwardly (e.g., away from the lure or other bait, etc.) along the fishing line 101 until the knot 102A contacts the upper eyelet 140 of the fishing line keeper 132 disposed along the upper boss 104. The knot 102A is sufficiently large enough relative to the size of the eyelet 140 such that the knot 102A is unable to pass through the upper eyelet 140. Accordingly, the knot 102A is operable as a stop to prevent any farther upward movement of the tube 106 and upper boss 104 along the fishing line 101. But as the knot 102A is on an opposite side of the tube 106 than the lure or other bait 103, the knot 102A allows the tube 106 and upper boss 104 to slide along the fishing line 101 downwardly towards the lure 103 (or other bait) when the lure is being retrieved and wound in by a fishing reel.

FIG. 1 also shows the knot 102B before being drawn tight and trimmed to illustrate the example Uni Knot that is used for the knot in this exemplary embodiment. The knot may be formed from a variety of suitable cords or strings, such as elastic cords or strings commonly used to string inexpensive jewelry like bracelets, etc. The string or cord used for the knot 102A preferably ties up relatively easily and grips small fishing line relatively well such that the knot 102A will hold its relative position along the fishing line 101 but will slip along the fishing line 101 to change the knot positioning when user applies a sufficient force.

As shown in FIG. 2, the first or upper boss 104 (broadly, an insert, retainer, or component) has been slidably removed from the straw 106 (broadly, a tube or tubular member) without having to remove the fishing float system 100 or the fishing lure 103 from the fishing line 101. The hollow interior of the straw 106 is thus accessible through the open end portion of the straw 106 from which the first boss 104 was slidably removed. FIG. 1 also shows items or objects (e.g., BBs 110A, glow stick 110B, split shot weights, rattles, weight, illumination, etc.) that may added into the hollow interior of the straw 106 to thereby adjust the fishing float system 100.

For example, BBs, rattles, and/or other noise makers objects 110A may be added into the hollow interior of the straw 106 to thereby adjust or convert the fishing float system 100 into a rattle float system. As another example, BBs, split shot weights, and/or other weighted objects 110A may be added into the hollow interior of the straw 106 to thereby adjust or convert the fishing float system 100 into a weighted float system. As a further example, one or more glow sticks 110B, LEDs, and/or other light sources may be added into the hollow interior of the straw 106 to thereby adjust or convert the fishing float system 100 into a lighted float system.

After the items or objects 110 are added into the hollow interior of the straw 106, the removed boss 104 may be slidably inserted back into the open end portion of the straw 106 to thereby define a substantially water tight seal that prevents or inhibits the ingress of water into the hollow interior of the straw 106.

The fishing float system 100 may be used with straws 106 having different lengths. For example, the fishing float system 100 may be used with a different straw that is shorter or longer than the straw 106 shown in FIGS. 1 and 2. Or, a shorter straw 106 may be the same straw that has been cut (e.g., with scissors, etc.) to thereby shorten its overall length. A conventional pair of scissors may be used for cutting a straw or other tubular member to reduce its overall length and thereby easily adjust one or more features (e.g., bite sensitivity adjustment, water displacement adjustment, etc.) of the fishing float system 100 according to exemplary embodiments.

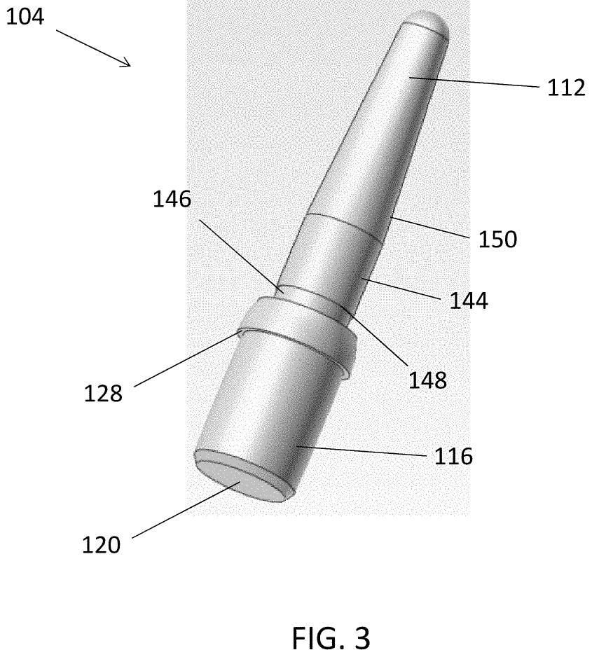

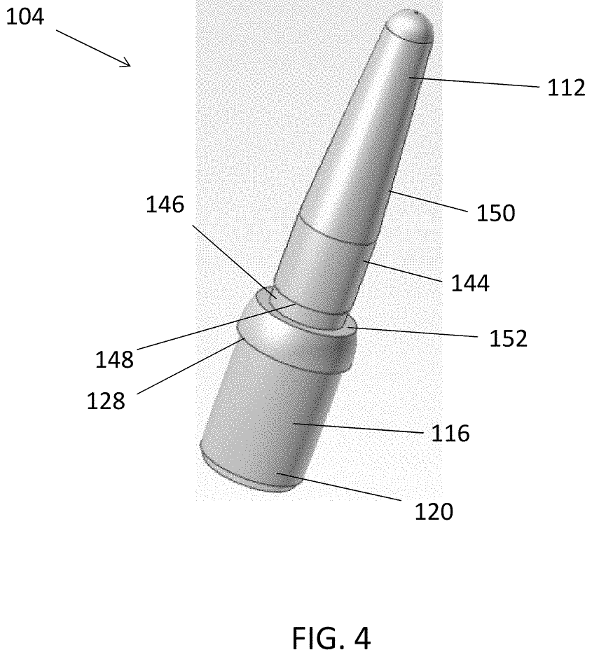

With reference to FIGS. 3 and 4, the boss 104 includes upper and lower (or first and second) end portions 112, 116. The first end portion 112 of the boss 104 may be configured to have an aerodynamic profile (e.g., a nose portion having a one-half elliptical profile shape, conical shape, etc.) and/or otherwise configured to have a relatively low or reduced wind resistance or drag when the fishing float system 100 is flying through the air after being cast towards the water.

The second end portion 116 of the boss 104 includes a tube receiver 120 configured to be engagingly received within (e.g., friction or interference fit into, etc.) the open end portion of the tube 106. For example, the tube receiver 120 may have an outer diameter slightly larger than an inner diameter of the tube 106. The configuration and relative sizing of the tube receiver 120 to the tube 106 preferably creates a substantially water tight seal between the boss 104 and the tube 106 that substantially prevents or inhibits the ingress of water into the hollow interior of the tube 106. The bottom portion of the tube receiver 120 may be chamfered or tapered to facilitate insertion into the open end portion of the tube 106 and to provide a thumbnail purchase (hold) for removal of the boss 104 from the tube 106.

In alternative embodiments, the tube receiver may include a tube keeper or protruding portion (e.g., a rib, etc.) that extends circumferentially along an outer circumference of the second end portion. In such alternative embodiments, the tube keeper may have an outer diameter slightly larger than an inner diameter of the tube 106. The configuration and relative sizing of the tube keeper to the tube may help create or improve a substantially water tight seal between the boss and the tube.

The second end portion 116 includes a stop 128 (e.g., a step, a shoulder portion, etc.) having a diameter about equal to or larger than an outer diameter of the tube 106. The stop 128 is operable for inhibiting sliding movement of the tube 106 upwardly beyond the stop 128 when the tube 106 contacts the stop 128.

The fishing float system 100 further includes a fishing line keeper 132. In this exemplary embodiment, the fishing line keeper 132 includes a coil spring 136 and eyelet 140 as also shown in FIGS. 5 and 6.

The coil spring 136 is disposed along or around a spring keeper 144 of the boss 104 (FIGS. 3 and 4). The coil spring 136 is retained between first and second stops 148, 152 (e.g., steps, shoulder portions, etc.) of the boss 104. By way of example, an inside diameter of the coil spring 136 may be slightly smaller than the diameter of the spring keeper 144 of the boss 104, which relative sizing helps to retain the positioning of the coil spring 136 along the spring keeper 144 of the boss 104.

The stops 148 and/or 152 may also be configured (e.g., located, sized, etc.) to inhibit or prevent fishing line from falling out of the open eyelet 140 while in use. Accordingly, exemplary embodiments are disclosed of methods for attaching a bobber or float to fishing line using an open eyelet and strategically located elevated/protruding surface(s) (e.g., shoulder(s), etc.) to prevent or inhibit fishing line from inadvertently falling out of the open eyelet while in use.

The stops 148, 152 may have a diameter about equal to the outer diameter of the coil spring 136. The spring keeper 144 may have a diameter about equal to a sum of the inner diameter of the coil spring 136 and diameter of the wire (or other material) used for the coil spring 136.

The eyelet 140 may be used when the fishing float system 100 is being used as a slip float. For example, as shown in FIGS. 1 and 2, a knot 102A may be attached to a fishing line 101, which, in turn, may be slidably thread or positioned through the eyelet 140 of the fishing line keeper 132. The knot 102A may be sufficiently large enough relative to the eyelet 140 such that the knot 102A is unable to pass through the eyelet 140. Accordingly, the tube 106 and upper boss 104 may be slidable upwardly (e.g., away from the lure 103 or other bait, etc.) along the fishing line 101 until the knot 102A contacts the eyelet 140, whereby the knot 102A and eyelet 140 cooperate to prevent any farther upward movement of the tube 106 and upper boss 104 along the fishing line 101.

As shown in FIGS. 3 and 4, the spring keeper 144 of the boss 104 may include a tapered portion 150 (e.g., tapered rod, etc.). The tapered portion 150 may be configured such that its diameter tapers or decreases along the tapered portion 150 in a direction defined from from the second end portion 116 towards the first end portion 112. In this example, the fishing float system 100 may be attached to fishing line 101 by using the open end coil spring 136 over the tapered portion 150 of the boss 104. Accordingly, fishing lines of varying diameter may therefore wedge between the coil spring 136 and the tapered portion 150 of the boss 104 at some point along the taper of the tapered portion 150.

The coil spring 136 may be positioned along the spring keeper 144 of the boss 104 such that at least a bottom coil or portion 160 of the coil spring 136 is within a groove or recessed portion 146 of the boss 104. The groove or recessed portion 146 may be defined generally between the first and second stops 148, 152 (e.g., steps, shoulder portions, etc.) of the boss 104. The stops 148 and/or 152 may also be configured (e.g., located, sized, etc.) to inhibit or prevent fishing line from falling out of the open eyelet 140 of the coil spring 136 while in use. The groove or recessed portion 146 may serve to provide clearance for the fishing line 101 to pass freely under the tip or free end portion of the open end eyelet 140.

The coil spring 136 may be configured with a constant coil pitch. Alternatively, the coil spring 136 may be configured such that the spacing or coil pitch varies to accommodate for different weight fishing line. For example, first and second adjacent coils may be spaced apart by a distance that is greater than the distance separating third and fourth adjacent coils. The greater pitch between the first and second coils may be used to accommodate (e.g., securely retain without slippage, etc.) heavier weight fishing line (e.g., 20 pound test fishing line, etc.) between the first and second coils. The smaller pitch between the third and fourth coils may be used to accommodate (e.g., securely retain without slippage, etc.) lighter weight fishing line (e.g., 4 pound test fishing line, etc.) between the third and fourth coils. Alternative embodiments, however, may include a coil spring that is configured differently, e.g., with a constant coil pitch, with more or less than six coils, etc.

The fishing line keeper 132 may be made from stainless steel wire having a diameter of about 0.20 inches. The top coil of the coil spring 136 may comprise a 225 degree flat coil with a generally flat eyelet 140. The bottom coil of the coil spring 136 may comprise a 240 degree flat coil. The coil spring 136 may include a generally flat portion 160, which may be defined by a single flat coil or turn. The flat portion 160 of the coil spring 136 may be configured to lie flush or abut against the stop 152 of the boss 104. The exemplary materials and dimensions provided in this paragraph and elsewhere in this patent application are examples only as other exemplary embodiments may be configured differently, e.g., larger, smaller, made from other materials besides stainless steel, etc.

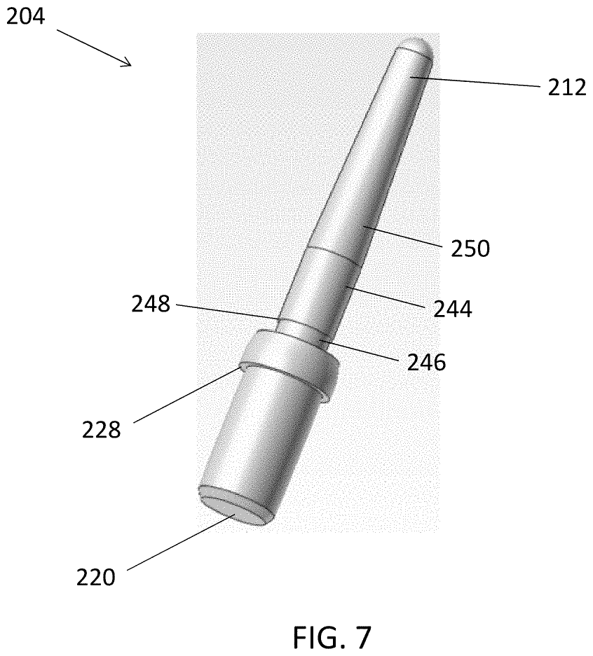

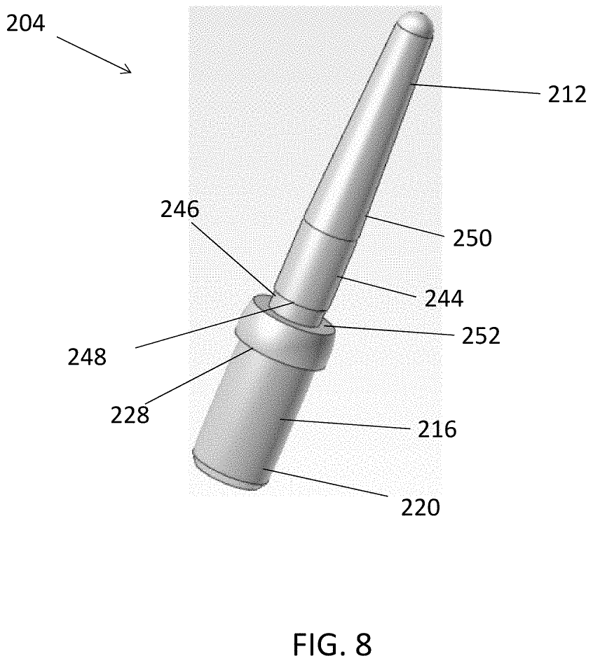

FIGS. 7 and 8 illustrate another exemplary boss 204 (broadly, an insert, retainer, or component) according to another exemplary embodiment. The boss 204 is configured to be slidably and engagingly received within an open end portion of a tube or tubular member of a fishing float system (e.g., fishing float system 100 (FIGS. 1 and 2), etc.). The engagement of the boss 204 within the open end portion of a tube or tubular member (e.g., straw, rubber tube, plastic tube, tubular member having a round, circular, or non-circular cross section, etc.) preferably creates a substantially water tight seal between the boss 204 and the tube that substantially prevents or inhibits the ingress of water into the hollow interior of the tube.

The boss 204 includes upper and lower (or first and second) end portions 212, 216. The first end portion 212 of the boss 204 may be configured to have an aerodynamic profile (e.g., a nose portion having a one-half elliptical profile shape, conical shape, etc.) and/or otherwise configured to have a relatively low or reduced wind resistance or drag when the fishing float system 200 is flying through the air after being cast towards the water.

The second end portion 216 of the boss 204 includes a tube receiver 220 configured to be engagingly received within (e.g., friction or interference fit into, etc.) the open end portion of the tube 206. For example, the tube receiver 220 may have an outer diameter slightly larger than an inner diameter of the tube 206. The configuration and relative sizing of the tube receiver 220 to the tube 206 preferably creates a substantially water tight seal between the boss 204 and the tube 206 that substantially prevents or inhibits the ingress of water into the hollow interior of the tube 206. The bottom portion of the tube receiver 220 may be chamfered or tapered to facilitate insertion into the open end portion of the tube 206 and to provide a thumbnail purchase (hold) for removal of the boss 204 from the tube 206.

The second end portion 216 includes a stop 228 (e.g., a step, a shoulder portion, etc.) having a diameter about equal to or larger than an outer diameter of the tube 206. The stop 228 is operable for inhibiting sliding movement of the tube 206 upwardly beyond the stop 228 when the tube 206 contacts the stop 228.

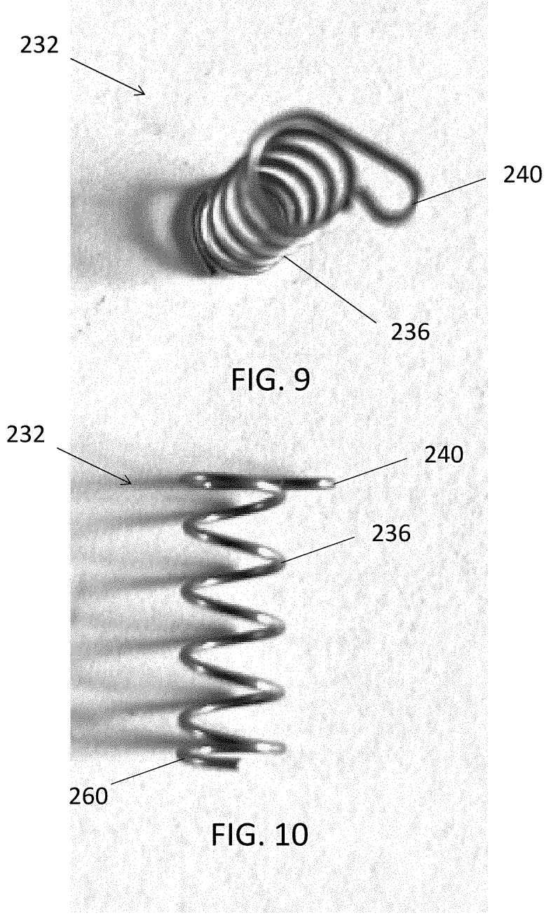

The fishing float system 200 further includes a fishing line keeper 232. In this exemplary embodiment, the fishing line keeper 232 includes a coil spring 236 and eyelet 240 as also shown in FIGS. 9 and 10.

The coil spring 236 is disposed along or around a spring keeper 244 of the boss 204 (FIGS. 7 and 8). The coil spring 236 is retained between first and second stops 248, 252 (e.g., steps, shoulder portions, etc.) of the boss 204. By way of example, an inside diameter of the coil spring 236 may be slightly smaller than the diameter of the spring keeper 244 of the boss 204, which relative sizing helps to retain the positioning of the coil spring 236 along the spring keeper 244 of the boss 204.

The stops 248 and/or 252 may also be configured (e.g., located, sized, etc.) to inhibit or prevent fishing line from falling out of the open eyelet 240 while in use. Accordingly, exemplary embodiments are disclosed of methods for attaching a bobber or float to fishing line using an open eyelet and strategically located elevated/protruding surface(s) (e.g., shoulder(s), etc.) to prevent or inhibit fishing line from inadvertently falling out of the open eyelet while in use.

The stops 248, 252 may have a diameter about equal to the outer diameter of the coil spring 236. The spring keeper 244 may have a diameter about equal to a sum of the inner diameter of the coil spring 236 and diameter of the wire (or other material) used for the coil spring 236. The eyelet 240 may be used when the fishing float system is being used as a slip float as disclosed herein and shown in FIGS. 1 and 2.

As shown in FIGS. 7 and 8, the spring keeper 244 of the boss 204 may include a tapered portion 250 (e.g., tapered rod, etc.). The tapered portion 250 may be configured such that its diameter tapers or decreases along the tapered portion 250 in a direction defined from from the second end portion 216 towards the first end portion 212. The fishing float system may be attached to a fishing line by using the open end coil spring 236 over the tapered portion 250 of the boss 204. Accordingly, fishing lines of varying diameter may therefore wedge between the coil spring 236 and the tapered portion 250 of the boss 204 at some point along the taper of the tapered portion 250.

The coil spring 236 may be positioned along the spring keeper 244 of the boss 204 such that at least a bottom coil or portion 260 of the coil spring 236 is within a groove or recessed portion 246 of the boss 204. The groove or recessed portion 246 may be defined generally between the first and second stops 248, 252 (e.g., steps, shoulder portions, etc.) of the boss 204. The stops 248 and/or 252 may also be configured (e.g., located, sized, etc.) to inhibit or prevent fishing line from falling out of the open eyelet 240 of the coil spring 236 while in use. The groove or recessed portion 246 may serve to provide clearance for the fishing line 201 to pass freely under the tip or free end portion of the open end eyelet 240.

The coil spring 236 may be configured with a constant coil pitch. Alternatively, the coil spring 236 may be configured such that the spacing or coil pitch varies to accommodate for different weight fishing line. For example, first and second adjacent coils may be spaced apart by a distance that is greater than the distance separating third and fourth adjacent coils. The greater pitch between the first and second coils may be used to accommodate (e.g., securely retain without slippage, etc.) heavier weight fishing line (e.g., 20 pound test fishing line, etc.) between the first and second coils. The smaller pitch between the third and fourth coils may be used to accommodate (e.g., securely retain without slippage, etc.) lighter weight fishing line (e.g., 4 pound test fishing line, etc.) between the third and fourth coils. Alternative embodiments, however, may include a coil spring that is configured differently, e.g., with a constant coil pitch, with more or less than six coils, etc.

The fishing line keeper 232 may be made from stainless steel wire having a diameter of about 0.20 inches. The top coil of the coil spring 236 may comprise a 225 degree flat coil with a generally flat eyelet 240. The bottom coil of the coil spring 236 may comprise a 240 degree flat coil. The coil spring 236 may include a generally flat portion 260, which may be defined by a single flat coil or turn. The flat portion 260 of the coil spring 236 may be configured to lie flush or abut against the stop 252 of the boss 204. The exemplary materials and dimensions provided in this paragraph and elsewhere in this patent application are examples only as other exemplary embodiments may be configured differently, e.g., larger, smaller, made from other materials besides stainless steel, etc.

Example features, the scale, dimensions, materials, etc. are provided for illustration and not for purposes of limitation as fishing float systems in other exemplary embodiments may be configured differently, e.g., larger, smaller, different relative sizes, different materials, different shapes, with more or less features, etc. For example, an exemplary embodiment of a fishing float system disclosed herein (e.g., fishing float system 100 (FIGS. 1 and 2), may provide all of the features and/or advantages set forth below, while other exemplary embodiments may provide less than all and/or different features than set forth below.
attachable and removable to fishing line without removing lure; and
selectively usable as a fixed float, a sliding float, a slip float, a popping float by adding a popper with an optional boss, a hooked float by adding a hook, a rattle float; and
water displacement adjustment;
speed of lure descent adjustment;
strike or bite sensitivity adjustment (e.g., by reducing tube length, etc.);
adjustment to the horizontal floating length atop the water;
adjustment to the vertical viewable length above the water;
weight float when desirable (e.g., add weight into the hollow interior of tube, etc.);
accommodates various fishing line weights (e.g., via coil spring and tapered portion of boss, etc.);
relatively inexpensive (e.g., bosses may be injection molded plastic and usable with commercially available/conventional/preexisting drinking or soda straws, etc.);
relatively quick and easy adjustability (e.g., remove a boss, shorten length of tube and/or add/remove items or objects into/from hollow interior of tube, add boss, etc.); and
allows the slip mode without threading the line end to end through the interior of the float, thereby substantially eliminating cohesive and adhesive drag as is in conventional floats.

Various straws and other tubes and tubular members may be used with fishing float systems including commercially available, conventional, and/or preexisting drinking straws, soda straws, etc. Accordingly, exemplary embodiments include bosses (broadly, inserts, retainers, or components) that allow conventional tubes (e.g., plastic straws, etc.) to be used as fishing bobbers. But the fishing float systems disclosed herein are not limited to use with only drinking straws or soda straws as other exemplary embodiments may be configured for use with different tubular members or tubes, e.g., larger tubes, smaller tubes, tubes having non-circular profiles, tubes made of different materials, other thin-walled tubes, etc. For example, a fishing float system may be used with a tube made of plastic, rubber, or suitable material that is capable of being press fit or forced over a lower portion (e.g., tube receiver, etc.) of a boss without splitting the tube walls and that is capable of forming substantially water proof seal therebetween until removed with a reasonable force. As another example, a fishing float system may be used with a tube that is considerably larger than a drinking straw or soda straw such as when fishing with larger gear for larger saltwater or freshwater fish from a beach, surf fishing, deep sea saltwater fishing, etc.

In exemplary embodiments, a fishing float system may be configured to allow the speed of lure descent to be adjusted relatively quickly and easily. In such exemplary embodiments, a fishing float system may be reconfigured to controllably change the speed at which a lure descends into the water by misalignment of the eyelets such that the line must pass partially or completely around the straw or other tube, thereby creating drag that slows the line speed downwardly through the misaligned eyelets. As the lure and fishing float system descend, the water pressure applied to the tube's walls will increase at a rate of about 0.435 pounds per square inch (psi). At a depth of 20 feet, for example, water pressure on the tube wall will be about 8.67 psi. If the increasing water pressure at greater fishing depths is not accommodated, then the thin-walled tube (e.g., drinking straw, soda straw, etc.) may collapse and/or one or more bosses may be forced out due to the higher water pressure. Therefore, exemplary embodiments of the fishing float systems are disclosed herein that may configured for deeper water fishing and the higher water pressures associated therewith. In such exemplary embodiments, a fishing float system may include a stronger thicker-walled tube capable of withstanding the higher water pressures in deeper water. Depending on the strength and wall thickness, the tube might not have the ability to expand over a tube receiver of a boss. In which case, a boss may be provided with an O-ring or other elastomeric sealing member configured to be engagingly received (e.g., resiliently compressed, etc.) within the open end portion of the tube such that a substantially water tight seal is defined between the O-ring and the tube. Depending on the tube's wall thickness, a more substantial method of cutting the tube to reduce its length may be needed instead of a conventional pair of scissors.

Exemplary embodiments disclosed herein may provide one or more (but not necessarily any or all) of the advantages or features disclosed herein. For example, a fishing float system disclosed herein may be attachable to and removable from a fishing line without having to first remove the baited hook or lure from the fishing line.

A fishing float system disclosed herein may be adjustable on the fly such that the fishing float system can be adjusted without having to remove the float system from the fishing line and without having to remove the baited hook or lure from the fishing line. The fishing float system may be attached to a fishing line above a fishing lure. After using the fishing float system, the user may want to adjust one or more features (e.g., weight, length, illumination, rattle, bite sensitivity, water displacement, speed of lure descent, horizontal floating length atop the water, vertical viewable length above the water, etc.) of the fishing float system. In which case, the user may make the adjustment without having to remove either the fishing lure or the first and second bosses of the float system from the fishing line.

Instead, the fishing lure and the first and second bosses may remain attached to the fishing line while the user makes the adjustment(s) to the fishing float system. For example, the user may slidably remove the first or second boss from a straw or other tube, cut the straw to thereby shorten the straw, and slidably insert the previously removed first or second boss back into the open end portion of the now shorter straw. Additionally, or alternatively, the user may slidably remove the first or second boss from the straw or other tube to thereby obtain access into the hollow interior of the straw. The user may then add items/objects into and/or remove items/objects from within the hollow interior of the straw, such as rattle/noise-making features (e.g., BBs, ball bearings, other noise makers, etc.), illumination (e.g., one or more glow sticks, LEDs, other light sources, etc.), weight (e.g., split shot weights, etc.), etc. After adding or removing the items or objects or otherwise making the adjustment(s) to the fishing float system, the user may then slidably insert the previously removed first or second boss back into the open end portion of the straw such that a substantially water tight seal is defined between the boss and the straw, which prevents or inhibits the ingress of water into the hollow interior of the straw.

Exemplary embodiments of the fishing float systems disclosed herein may be relatively easily and quickly reconfigured or adjusted with different functionality, e.g., by adding one or more various features into the hollow interior of a tube of a fishing float system to thereby selectively configure the fishing float system as any one of a fixed float, a sliding float, a slip float, a popping float by adding a popper with an optional boss, a hooked float by adding a hook, a rattle float, etc. Exemplary embodiments of the fishing float systems disclosed herein may be relatively easily adjustable in weight, water displacement, sensitivity to a bite, method of weighting, selection of orientation when deployed from vertical or horizontal, rate of lure decent, etc. This is unlike some conventional floats that only have a fixed, non-adjustable, limited use and thus are capable of only being used in one or two particulars way. Although various functions provided by exemplary embodiments of the fishing float systems disclosed herein may be present in various conventional float systems, the functionality of such conventional float systems is either fixed or not adjustable relatively quickly and easily as compared to exemplary embodiments of the fishing float systems disclosed herein. Accordingly, exemplary embodiments of the fishing float systems disclosed herein may advantageously take the place of and provide the same or similar functionality of numerous conventional floats having either a fixed, non-adjustable, limited functionality or a functionality that is not adjustable relatively quickly and easily.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific numerical dimensions and values, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter may be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one fishing float system comprises or includes the feature(s) in at least one exemplary embodiment. As used herein, the singular forms “a”, “an” and “the” may be intended to include the plural forms as well, unless the context clearly indicates otherwise. The terms “comprises,” “comprising,” “includes,” “including,” “has,” “have,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and may be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fishing float system comprising:
a tube including first and second open end portions and a hollow interior;
a first insert configured to be slidably and engagingly received within the first open end portion of the tube;
a second insert configured to be slidably and engagingly received within the second open end portion of the tube;
a first coil spring disposed along a first portion of the first insert for attaching the first insert to a fishing line;
a second coil spring disposed along a second portion of the second insert for attaching the second insert to the fishing line;
whereby the engagement of the first and second inserts within the first and second open end portions of the tube creates substantially water tight seals between the first and second inserts and the tube that substantially prevents or inhibits the ingress of water into the hollow interior of the tube, thereby allowing the tube to be usable as a fishing bobber or float

2. The fishing float system of claim 1, wherein:
the first insert includes a first tapered portion along which the first coil spring is disposed, whereby the first tapered portion and the first coil spring are configured to allow fishing lines of varying diameter to wedge between the first coil spring and the first tapered portion at different locations along a taper of the first tapered portion, thereby allowing the first insert to be attachable to the fishing lines of varying diameter; and/or
the second insert includes a second tapered portion along which the second coil spring is disposed, whereby the second tapered portion and the second coil spring are configured to allow fishing lines of varying diameter to wedge between the second coil spring and the second tapered portion at different locations along a taper of the second tapered portion, thereby allowing the second insert to be attachable to the fishing lines of varying diameter.

3. The fishing float system of claim 1, wherein:
the first coil spring includes a first open eyelet for receiving the fishing line therein, and the first insert includes a first protruding surface configured to inhibit the fishing line from inadvertently falling out of the first open eyelet; and/or
the second coil spring includes a second open eyelet for receiving the fishing line therein, and the second insert includes a second protruding surface configured to inhibit the fishing line from inadvertently falling out of the second open eyelet.

4. The fishing float system of claim 1, wherein the tube comprises a plastic straw, a soda straw, and/or a drinking straw.

5. A fishing float system comprising at least one insert configured to be slidably and engagingly received within an open end portion of a tube having a hollow interior, whereby engagement of the at least one insert within the open end portion of the tube creates a substantially water tight seal between the at least one insert and the tube that substantially prevents or inhibits the ingress of water into the hollow interior of the tube thereby allowing the tube to be usable as a fishing bobber or float.

6. The fishing float system of claim 5, further comprising a coil spring disposed along a portion of the at least one insert, whereby the at least one insert is attachable to a fishing line via a spring retention force that retains the fishing line between one or more coils of the coil spring and the portion of the at least one insert.

7. The fishing float system of claim 5, further comprising a coil spring disposed along a tapered portion of the at least one insert, wherein the tapered portion and the coil spring are configured to allow fishing lines of varying diameter to wedge between the coil spring and the tapered portion at different locations along a taper of the tapered portion, whereby the at least one insert is attachable to the fishing lines of varying diameter.

8. The fishing float system of claim 5, further comprising a coil spring disposed along a portion of the at least one insert for attaching the at least one insert to a fishing line, whereby the at least one insert is removable from the tube without having to detach the at least one insert or a lure from the fishing line.

9. The fishing float system of claim 5, further comprising a coil spring disposed along a portion of the at least one insert for attaching the at least one insert to a fishing line.

10. The fishing float system of claim 9, wherein:
the at least one insert comprises first and second stops; and
the coil spring is retained between the first and second stops of the at least one insert.

11. The fishing float system of claim 9, wherein:
the coil spring includes an open eyelet for receiving the fishing line therein; and
the at least one insert includes at least one protruding surface configured to inhibit the fishing line from inadvertently falling out of the open eyelet while in use.

12. The fishing float system of claim 9, wherein:
the at least one insert comprises first and second stops and a recessed portion defined generally between the first and second stops; and
at least a bottom portion of the coil spring is disposed within the recessed portion and retained between the first and second stops of the at least one insert.

13. The fishing float system of claim 9, wherein:
the coil spring includes an eyelet for slidably receiving the fishing line therein; and
the fishing float system further comprises an elastic cord or string configured to be tied into a knot along the fishing line above the at least one insert such that the knot is larger than an opening of the eyelet and operable as a stop to prevent any farther upward movement of the at least one insert along the fishing line beyond the knot.

14. The fishing float system of claim 9, wherein:
the at least one insert comprises upper and lower stops;
the coil spring includes generally flat upper and lower portions each defined by a flat coil or turn of the coil spring; and
the generally flat upper and lower portions of the coil spring are configured to lie flush and/or abut against the respective upper and lower stops of the at least one insert, whereby the coil spring is retained between the upper and lower stops of the at least one insert.

15. The fishing float system of claim 5, wherein the at least one insert comprises first and second inserts configured to be slidably and engagingly received within respective first and second open end portions of the tube, whereby the engagement of the first and second inserts within the first and second open end portions of the tube creates substantially water tight seals between the first and second inserts and the tube that substantially prevents or inhibits the ingress of water into the hollow interior of the tube.

16. The fishing float system of claim 5, wherein the at least one insert includes first and second end portions, and wherein:
the second end portion is configured to form a friction fit and/or an interference fit with the tube when the second end portion of the at least one insert is engaged within the open end portion of the tube; and/or
a bottom portion of the second end portion is chamfered and/or tapered to facilitate insertion into the open end portion of the tube.

17. The fishing float system of claim 5, wherein the at least one insert includes a stop having a diameter about equal to or larger than an outer diameter of the tube, whereby the stop is operable for inhibiting sliding movement of the tube upwardly beyond the stop when the tube contacts the stop.

18. The fishing float system of claim 5, wherein:
the fishing float system includes the tube;
the tube comprises a plastic straw having first and second open end portions and a hollow interior; and
the at least one insert comprises first and second inserts configured to be slidably and engagingly received within the respective first and second open end portions of the plastic straw;
whereby the engagement of the first and second inserts within the first and second open end portions of the plastic straw creates substantially water tight seals between the first and second inserts and the plastic straw that substantially prevents or inhibits the ingress of water into the hollow interior of the plastic straw, thereby allowing the plastic straw to be usable as a fishing bobber or float.

19. A method comprising slidably positioning first and second inserts within respective first and second open end portions of a tube to thereby create substantially water tight seals between the first and second inserts and the tube that substantially prevents or inhibits the ingress of water into a hollow interior of the tube, thereby allowing the tube to be usable as a fishing bobber or float.

20. The method of claim 19, further comprising:
attaching the first insert to a fishing line by positioning the fishing line between one or more coils of a first coil spring disposed along a portion of the first insert; and/or
attaching the second insert to the fishing line by positioning the fishing line between one or more coils of a second coil spring disposed along a portion of the second insert.

21. The method of claim 20, wherein:
the first insert includes a first tapered portion along which the first coil spring is disposed, whereby the first tapered portion and the first coil spring are configured to allow fishing lines of varying diameter to wedge between the first coil spring and the first tapered portion at different locations along a taper of the first tapered portion, thereby allowing the first insert to be attachable to the fishing lines of varying diameter; and/or
the second insert includes a second tapered portion along which the second coil spring is disposed, whereby the second tapered portion and the second coil spring are configured to allow fishing lines of varying diameter to wedge between the second coil spring and the second tapered portion at different locations along a taper of the second tapered portion, thereby allowing the second insert to be attachable to the fishing lines of varying diameter.

22. The method of claim 19, further comprising:
attaching the first insert to a fishing line by positioning the fishing line within a first open eyelet of a first coil spring disposed along a portion of the first insert, and using a first protruding surface of the first insert to inhibit the fishing line from inadvertently falling out of the first open eyelet while in use; and/or
attaching the second insert to a fishing line by positioning the fishing line within a second open eyelet of a second coil spring disposed along a portion of the second insert, and using a second protruding surface of the second insert to inhibit the fishing line from inadvertently falling out of the second open eyelet while in use.
